(19) United States
(12) Patent Application Publication
(10) Pub. No.: US 2024/0077168 A1
(43) Pub. Date: Mar. 7, 2024

(54) MAGNETIC SUCTION CUP STAND DEVICE

(71) Applicant: Dongguan Winking Technology Co., Ltd, Dongguan (CN)

(72) Inventor: Zhixuan Li, Dongguan (CN)

(21) Appl. No.: 18/388,555

(22) Filed: Nov. 10, 2023

(30) Foreign Application Priority Data
Aug. 18, 2023 (CN) 202322227655.X

(51) Int. Cl. F16M 11/04; G03B 17/56

(52) U.S. Cl. CPC F16M 11/04; G03B 17/561; F16B 47/00

(57) ABSTRACT

The present disclosure provides a magnetic suction cup stand device, including a suction cup main body, a surface cover, a magnet supporting plate, and a plurality of magnets; the suction cup main body is arranged at a bottom of the surface cover; the magnet supporting plate is arranged between the suction cup main body and the surface cover; the plurality of magnets are uniformly arranged at a bottom of the magnet supporting plate; and the surface cover is provided with a connecting portion connected to a camera tripod stand. Compared with the prior art, the magnetic suction cup stand device of the present disclosure has the following advantages: One or more suction cup structures can be designed at the bottom of a suction cup, thus improving the vacuum suction force.

### TECHNICAL FIELD

The present disclosure relates to the technical field of camera tripod stand, and particularly, to a magnetic suction cup stand device.

### BACKGROUND

In order to mount a capturing device such as a mobile phone or a camera at a designated fixed position for ease of use, a magnetic suction stand is often used. The magnetic suction stand is sucked to some fixed positions, so that the capturing devices such as the mobile phone or the camera can be quickly mounted and fixed.

The existing magnetic suction stand only has a magnetic suction function and a poor suction force. When the magnetic suction stand is used for vehicle-mounted photographing, a bumpy vehicle can easily cause the magnetic suction stand to fall off, which may cause damage to the capturing devices.

### SUMMARY

The present disclosure aims to overcome the defects and drawbacks in the prior art and to provide a magnetic suction cup stand device.

One embodiment of the present disclosure provides a magnetic suction cup stand device, including: a suction cup main body, a surface cover, a magnet supporting plate, and a plurality of magnets, wherein
the suction cup main body is arranged at a bottom of the surface cover; the magnet supporting plate is arranged between the suction cup main body and the surface cover; the plurality of magnets are uniformly arranged at a bottom of the magnet supporting plate; and the surface cover is provided with a connecting portion configured to be connected to a camera tripod stand.

In some optional implementations, an accommodating slot is arranged at a top of the suction cup main body; the magnet supporting plate is arranged in the accommodating slot; and the surface cover closes the accommodating slot.

In some optional implementations, a plurality of grooves are arranged at a bottom of the accommodating slot, and the magnets extend into the grooves in a one-to-one correspondence manner.

In some optional implementations, an inner wall of the suction cup main body is provided with a supporting portion; the supporting portion extends in a direction surrounding the magnet supporting plate; the supporting portion is provided with a positioning slot; a bottom end of the surface cover is provided with an annular positioning portion; and the positioning slot is in location fit with the annular positioning portion.

In some optional implementations, an inner wall of the accommodating slot is provided with an annular limiting slot, and a side edge of the magnet supporting plate is plugged into the annular limiting slot.

In some optional implementations, a bottom of the suction cup main body is provided with one or more suction cups.

In some optional implementations, the bottom of the suction cup main body is provided with a large suction cup and a small suction cup, and the small suction cup is arranged in the middle of the large suction cup.

In some optional implementations, the surface cover is fixedly connected to the magnet supporting plate through a plurality of screws.

In some optional implementations, the connecting portion is a threaded hole.

In some optional implementations, the surface cover is further provided with a ball head main body connected to the threaded hole; a bottom end of the ball head main body is in threaded fit with the threaded hole of the surface cover; the ball head main body is configured to be in rotating fit with the camera tripod stand.

Compared with the prior art, the magnetic suction cup stand device of the present disclosure has the following advantages: By the arrangement of a suction cup device, the magnetic suction stand has a magnetic suction force and can increase a vacuum suction force, so that the stability of the magnetic suction cup stand is improved. One or more suction cup structures can be designed at the bottom of a suction cup, thus improving the vacuum suction force.

In order to have a clearer understanding of the present disclosure, specific implementations of the present disclosure are described below in combination with the accompanying drawings.

### BRIEF DESCRIPTION OF THE DRAWINGS

FIG. 1 is a schematic structural diagram of a magnetic suction cup stand device according to one embodiment of the present disclosure;

FIG. 2 is an exploded view of a magnetic suction cup stand device according to one embodiment of the present disclosure;

FIG. 3 is a sectional view of a magnetic suction cup stand device according to one embodiment of the present disclosure;

FIG. 4 is a schematic structural diagram of a suction cup main body according to one embodiment of the present disclosure; and

FIG. 5 is a schematic structural diagram of a bottom of a magnetic suction cup stand device according to one embodiment of the present disclosure.

### DESCRIPTIONS OF REFERENCE NUMERALS

10: suction cup main body; 11: accommodating slot; 12: groove; 13: supporting portion; 14: positioning slot; 15: annular limiting slot; 16: large suction cup; 17: small suction cup; 20: surface cover; 21: annular positioning portion; 22: screw; 30: magnet supporting plate; 31: avoiding hole; 40: magnet; and 50: ball head main body.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some embodiments of the present disclosure, rather than all of the embodiments. All other embodiments obtained by a person of ordinary skill in the art based on the embodiments of the present disclosure without making creative efforts shall fall within the protection scope of the present disclosure. The terms “first” and “second” are used for descriptive purposes only and are not to be construed as indicating or implying relative importance or to implicitly indicate the number of technical features indicated. From this, features defined as “first” and “second” may explicitly or implicitly include at least one feature. In the description of the present disclosure, “plurality” means at least two, for example, two and three, unless explicitly specified otherwise. “Several” means one or more.

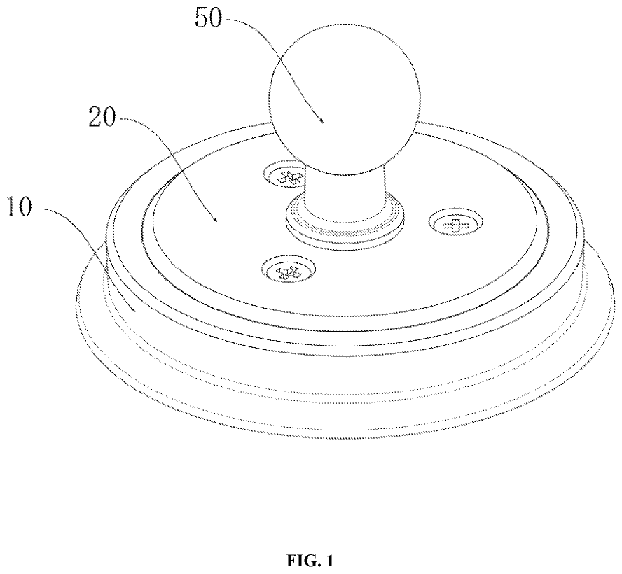

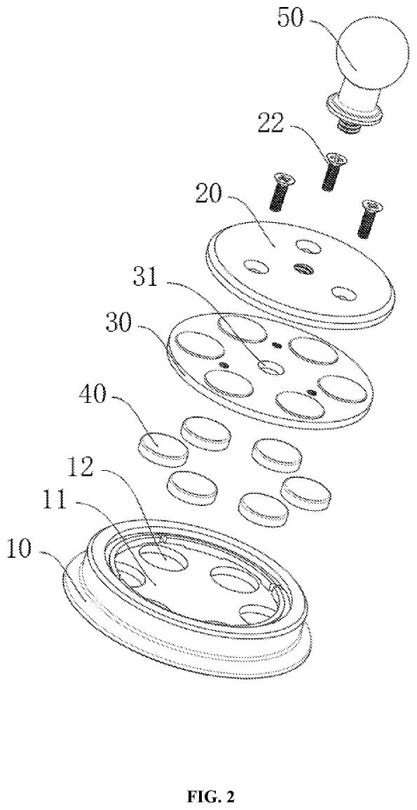

Referring to FIG. 1 and FIG. 2, a magnetic suction cup stand device includes a suction cup main body 10, a surface cover 20, a magnet supporting plate 30, and a plurality of magnets 40.

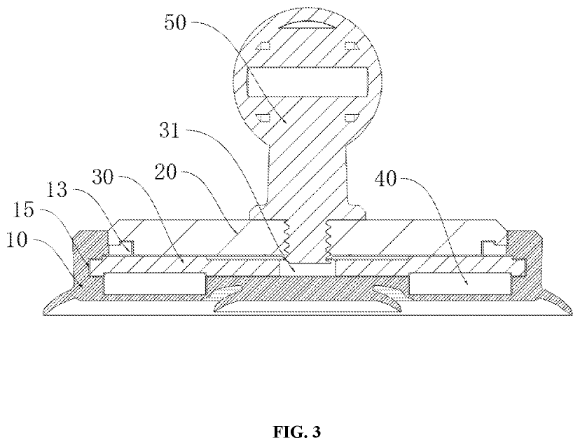

FIG. 3 shows a schematic structural diagram of a magnetic suction cup stand device according to one embodiment of the present disclosure. The suction cup main body 10 is arranged at a bottom of the surface cover 20. The magnet supporting plate 30 is arranged between the suction cup main body 10 and the surface cover 20. The plurality of magnets 40 are uniformly arranged at a bottom of the magnet supporting plate 30. The surface cover 20 is provided with a connecting portion configured to be connected to a camera tripod stand. During use, the suction cup main body 10 presses against a surface of a vehicle or a position of an automobile center console. Due to attraction of the magnets 40 to the structure of the vehicle, a suction cup edge of the suction cup main body 10 deforms under the driving of a magnetic force on the suction cup main body, so that a negative pressure cavity is formed between the suction cup main body and the surface of the vehicle or the position of the automobile center console, and the suction cup main body is sucked on the surface of the vehicle under the action of a vacuum atmospheric pressure, thus making the camera tripod stand more stable under dual protection of the suction force of the magnets 40 and the suction force of the suction cups. The camera tripod stand is configured to fix a capturing device, such as a mobile phone and a camera. Of course, users can also apply their own force to cause the suction cup main body to deform according to actual usage.

The magnets 40 can be embedded on the magnet supporting plate 30 and formed integrally with the magnet supporting plate 30.

A quantity of the magnets 40 can be selected according to a need. In this implementation, there are six magnets 40.

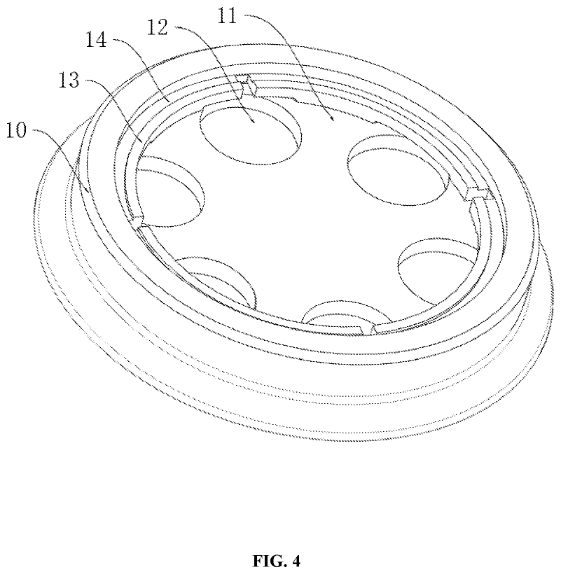

Referring to FIG. 4, in some optional implementations, an accommodating slot 11 is arranged at a top of the suction cup main body 10; the magnet supporting plate 30 is arranged in the accommodating slot 11; and the surface cover 20 closes the accommodating slot 11. Thus, the magnet supporting plate 30 and the magnets 40 are stably accommodated in the accommodating slot 11, which avoids the magnets 40 from being affected and corroded by an environment.

In some optional implementations, a plurality of grooves 12 are arranged at a bottom of the accommodating slot 11. The magnets 40 extend into the grooves 12 in a one-to-one correspondence manner, so that it is hard for the magnets 40 to deviate when the suction cup main body deforms.

In some optional implementations, an inner wall of the suction cup main body 10 is provided with a supporting portion 13; the supporting portion 13 extends in a direction surrounding the magnet supporting plate 30; the supporting portion 13 is provided with a positioning slot 14; a bottom end of the surface cover 20 is provided with an annular positioning portion 21; and the positioning slot 14 is in location fit with the annular positioning portion 21. Thus, the position of the surface cover 20 is more stable and does not easily deviate.

The suction cup main body is made of soft rubber and has elasticity.

In some optional implementations, an inner wall of the accommodating slot 11 is provided with an annular limiting slot 15, and a side edge of the magnet supporting plate 30 is plugged into the annular limiting slot 15. The annular limiting slot 15 can limit a position of the magnet supporting plate 30, so that the magnet supporting plate 30 is stably stuck in the accommodating slot 11.

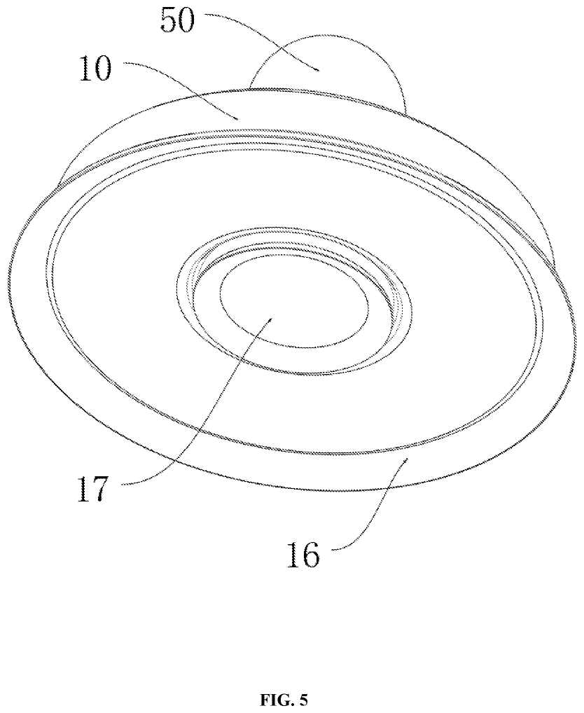

Referring to FIG. 5, in some optional implementations, a bottom of the suction cup main body 10 is provided with one or more suction cups, thus improving the vacuum suction force. In this implementation, the bottom of the suction cup main body 10 is provided with a large suction cup 16 and a small suction cup 17, and the small suction cup 17 is arranged in the middle of the large suction cup 16. By use of the large suction cup 16 and the small suction cup 17, the vacuum suction force can be effectively increased. Of course, a quantity of the suction cups can also be increased, and a specific setting manner can be changed according to an actual need.

In some optional implementations, the surface cover 20 is fixedly connected to the magnet supporting plate 30 through a plurality of screws 22, thereby ensuring stable fixation between the surface cover 20 and the magnet supporting plate 30.

In some optional implementations, the connecting portion is a threaded hole, and the camera tripod stand is in threaded fit with the threaded hole.

In some optional implementations, the surface cover 20 is further provided with a ball head main body 50 connected to the threaded hole; a bottom end of the ball head main body 50 is in threaded fit with the threaded hole of the surface cover 20, which facilitates mounting of the ball head main body 50 and the surface cover 20; the ball head main body 50 is configured to be in rotating fit with the camera tripod stand, which facilitates adjusting an angle of the camera tripod stand.

In order to avoid the magnet supporting plate 30 from blocking the bottom end of the ball head main body 50, in some optional implementations, an avoiding hole 31 is arranged in the middle of the magnet supporting plate 30. During mounting of the ball head main body 50, the bottom end of the ball head main body 50 passes through the threaded hole on the surface cover 20, and then the bottom end of the ball head main body 50 extends into the avoiding hole 31.

Although the embodiments of the present disclosure have been shown and described, it can be understood by those of ordinary skill in the art that various changes, modifications, substitutions, and variations can be made to these embodiments without departing from the principle and spirit of the present disclosure. The scope of the present disclosure is defined by the accompanying claims and their equivalents.

What is claimed is:

1. A magnetic suction cup stand device, comprising a suction cup main body, a surface cover, a magnet supporting plate, and a plurality of magnets, wherein
the suction cup main body is arranged at a bottom of the surface cover; the magnet supporting plate is arranged between the suction cup main body and the surface cover; the plurality of magnets are uniformly arranged at a bottom of the magnet supporting plate; and the surface cover is provided with a connecting portion configured to be connected to a camera tripod stand.

2. The magnetic suction cup stand device according to claim 1, wherein an accommodating slot is arranged at a top of the suction cup main body; the magnet supporting plate is arranged in the accommodating slot; and the surface cover closes the accommodating slot.

3. The magnetic suction cup stand device according to claim 2, wherein a plurality of grooves are arranged at a bottom of the accommodating slot, and the magnets extend into the grooves in a one-to-one correspondence manner.

4. The magnetic suction cup stand device according to claim 2, wherein an inner wall of the suction cup main body is provided with a supporting portion; the supporting portion extends in a direction surrounding the magnet supporting plate; the supporting portion is provided with a positioning slot; a bottom end of the surface cover is provided with an annular positioning portion; and the positioning slot is in location fit with the annular positioning portion.

5. The magnetic suction cup stand device according to claim 2, wherein an inner wall of the accommodating slot is provided with an annular limiting slot, and a side edge of the magnet supporting plate is plugged into the annular limiting slot.

6. The magnetic suction cup stand device according to claim 1, wherein a bottom of the suction cup main body is provided with one or more suction cups.

7. The magnetic suction cup stand device according to claim 6, wherein the bottom of the suction cup main body is provided with a large suction cup and a small suction cup, and the small suction cup is arranged in the middle of the large suction cup.

8. The magnetic suction cup stand device according to claim 1, wherein the surface cover is fixedly connected to the magnet supporting plate through a plurality of screws.

9. The magnetic suction cup stand device according to claim 1, wherein the connecting portion is a threaded hole.

10. The magnetic suction cup stand device according to claim 9, wherein the surface cover is further provided with a ball head main body connected to the threaded hole; a bottom end of the ball head main body is in threaded fit with the threaded hole of the surface cover; the ball head main body is configured to be in rotating fit with the camera tripod stand.
